(19) United States
(12) Patent Application Publication
(10) Pub. No.: US 2018/0091671 A1
(43) Pub. Date: Mar. 29, 2018

(54) Image Reading Apparatus and Image Reading Method That Simply Detect Document Direction in Reading of Book Document, and Recording Medium Therefor

(71) Applicant: Kyocera Document Solutions Inc., Osaka (JP)

(72) Inventor: Masataka Takemura, Osaka (JP)

(21) Appl. No.: 15/719,527

(22) Filed: Sep. 28, 2017

(30) Foreign Application Priority Data
Sep. 28, 2016 (JP) 2016-190450

(51) Int. Cl. H04N 1/00; G06K 9/00; H04N 1/387

(52) U.S. Cl. CPC H04N 1/00702; G06K 9/00469; H04N 2201/0081; H04N 1/00737; G06K 2209/501; H04N 1/3877

(57) ABSTRACT

An image reading apparatus includes an image reading unit and an image analysis unit. The image reading unit reads images of a plurality of original documents in sequence so as to generate an image data group including a plurality of pieces of image data. The image analysis unit analyzes the image data group to identify a body text region representing a body text of the original document. The image analysis unit identifies a page number region based on a position of the identified body text region. The page number region represents a page number. The image analysis unit determines a first position relationship as a positional relationship between the body text region and the page number region. The image analysis unit detects a disarranged image. The disarranged image is an image of an original document having a second position relationship different from the determined first position relationship.

### INCORPORATION BY REFERENCE

This application is based upon, and claims the benefit of priority from, corresponding Japanese Patent Application No. 2016-190450 filed in the Japan Patent Office on Sep. 28, 2016, the entire contents of which are incorporated herein by reference.

### BACKGROUND

Unless otherwise indicated herein, the description in this section is not prior art to the claims in this application and is not admitted to be prior art by inclusion in this section.

Recently, an individual digitization process for reading and digitizing a book document, such as a book original document, has been widely performed because of spread of viewers. In the reading of the book document, it is preferred that a rotation process be performed on the read image, which is read from the book document, in accordance with a direction where the book document is placed. In this rotation process, there is proposed a technique that identifies a binding portion of an original document based on a density reduction and a density increase in a scanning direction and analyzes a density histogram in the scanning direction, so as to determine a document direction.

### SUMMARY

An image reading apparatus according to one aspect of the disclosure includes an image reading unit and an image analysis unit. The image reading unit ensures placing at least one original document among a plurality of original documents constituting a book document. The image reading unit reads images of the plurality of original documents in sequence so as to generate an image data group including a plurality of pieces of image data. The image analysis unit analyzes the image data group to identify a body text region representing a body text of the original document. The image analysis unit identifies a page number region based on a position of the identified body text region. The page number region represents a page number. The image analysis unit determines a first position relationship as a positional relationship between the body text region and the page number region. The image analysis unit detects a disarranged image. The disarranged image is an image of an original document having a second position relationship different from the determined first position relationship.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a schematic configuration illustrating an overall configuration of an image forming apparatus according to one embodiment of the disclosure.

FIG. 2 illustrates contents of a book document reading process procedure according to the one embodiment.

FIGS. 3A and 3B illustrate explanatory diagrams illustrating exemplary page images of a book document in the book document reading process procedure according to the one embodiment.

FIG. 4 illustrates contents of a document direction identification process according to the one embodiment.

FIG. 5 illustrates an explanatory diagram illustrating a histogram analysis process in the document direction identification process according to the one embodiment.

FIG. 6 illustrates an explanatory diagram illustrating the histogram analysis process in the document direction identification process according to the one embodiment.

FIGS. 7A and 7B illustrate explanatory diagrams illustrating exemplary image reading of a book document according to a modification.

FIGS. 8A and 8B illustrate explanatory diagrams illustrating an exemplary operation display according to modifications.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes a configuration for implementing the disclosure (hereinafter referred to as “embodiment”) with reference to the drawings.

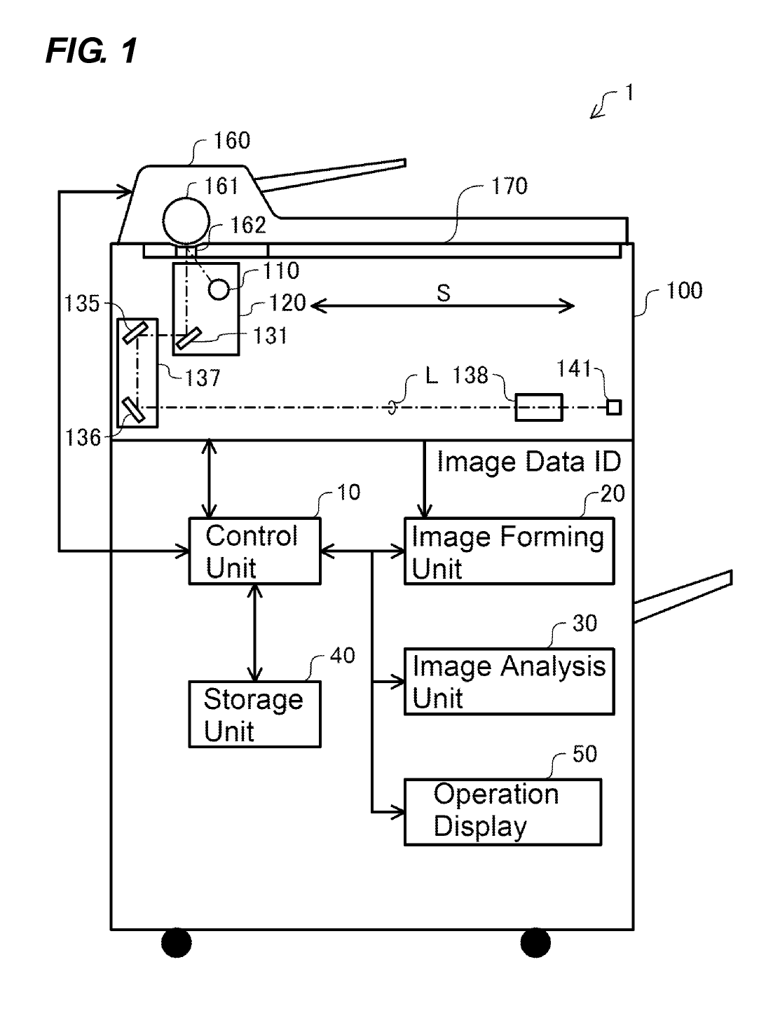

FIG. 1 illustrates a schematic configuration illustrating an overall configuration of an image forming apparatus 1 according to one embodiment of the disclosure. The image forming apparatus 1 includes a control unit 10, an image forming unit 20, an image analysis unit 30, a storage unit 40, an operation display 50, and an image reading unit 100. The image reading unit 100 includes an automatic document feeder (ADF) 160 and a platen 170, and reads images from an original document to generate image data ID as digital data. The image forming apparatus 1 has a small size and is, what is called, an A4 multi-functional peripheral. Thus, the platen 170 is not available for a book document placed in a two-page spread state.

While conveying print media (not illustrated), the image forming unit 20 forms images on the print media based on the image data ID and then discharges the print medium. When the image forming apparatus 1 is connected to an external terminal device, the image forming unit 20 forms images on the print media (not illustrated) based on the image data ID transmitted from the external terminal device and then discharges the print medium. The operation display 50 accepts an operation input from a user via a display (not illustrated), which functions as a touch panel, and various kinds of buttons and switches (not illustrated).

A conveyance direction (paper feed direction) of a print medium (not illustrated) is referred to as a sub-scanning direction S (see FIG. 1), and a direction perpendicular to the sub-scanning direction S is referred to as a main-scanning direction M.

The control unit 10 includes a main storage unit, such as a RAM and a ROM, and a control unit, such as a micro-processing unit (MPU) and a central processing unit (CPU). The control unit 10 has a controller function related to an interface, such as various I/Os, a universal serial bus (USB), a bus, and other hardware, and controls the entire image forming apparatus 1.

The storage unit 40 is a storage device constituted of a hard disk drive, a flash memory, or a similar medium, which are non-transitory recording media, and stores control programs and data for processes performed by, for example, the control unit 10 and the image analysis unit 30.

The image reading unit 100 includes a light source unit 110, a first reflecting mirror 131, a first carriage 120, a second reflecting mirror 135, a third reflecting mirror 136, a second carriage 137, a condensing lens 138, and an image sensor 141. The first reflecting mirror 131 reflects a reflected light L from the original document to the direction of the second reflecting mirror 135. The second reflecting mirror 135 reflects the reflected light L to the direction of the third reflecting mirror 136. The third reflecting mirror 136 reflects the reflected light L to the direction of the condensing lens 138. The condensing lens 138 forms an image with the reflected light L on a light receiving surface of the image sensor 141.

The first carriage 120 includes the light source unit 110 and the first reflecting mirror 131, and reciprocates in the sub-scanning direction S. The second carriage 137 includes the second reflecting mirror 135 and the third reflecting mirror 136, and reciprocates in the sub-scanning direction S. The first carriage 120 and the second carriage 137 are a part of a scanning mechanism, which is controlled by the control unit 10. The light source unit 110 ensures scanning of the original document in the sub-scanning direction S. This causes the image sensor 141 to output an analog electrical signal in accordance with a two-dimensional image on the original document placed on the platen 170, an A/D conversion is performed on this analog electrical signal, and thus the image data ID is generated.

The ADF 160 ensures placing a plurality of original documents, conveys the original documents one by one, and then images are automatically read. When the automatic document feeder (ADF) 160, which automatically conveys the original document, is used, the first carriage 120 and the second carriage 137 are fixed to predetermined sub-scanning positions to perform scanning by an automatic conveyance of the original documents. The ADF 160 may read not only a single-side but also simultaneously or sequentially read both sides.

The ADF 160 includes a paper feed roller 161 and a document reading slit 162. The paper feed roller 161 performs the automatic conveyance of the original documents, and the original documents are read via the document reading slit 162. In this case, the first carriage 120 is fixed to the predetermined sub-scanning position. This means that the light source unit 110, which is included in the first carriage 120, is also fixed to a predetermined position.

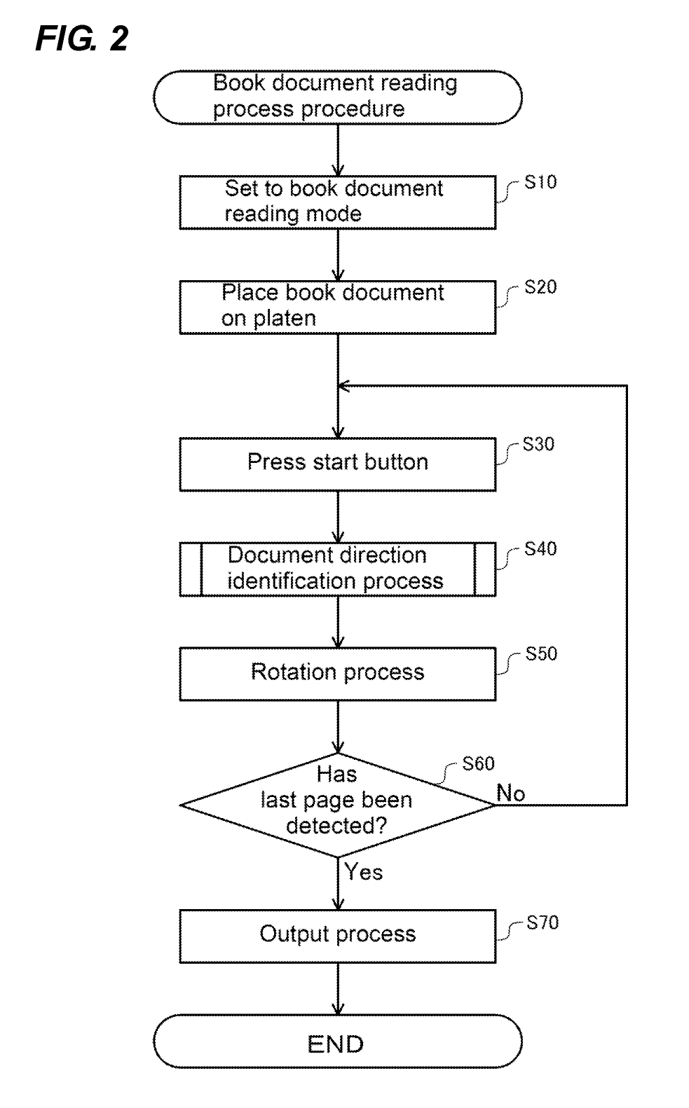

FIG. 2 illustrates contents of a book document reading process procedure according to the one embodiment. In the embodiment, the book document reading process procedure is a process that reads images from the book document, which is repeatedly placed for each page on the platen 170 while the pages of the book document are turned, so as to generate image data. Placing each page is performed because the platen 170 is not available for a book document placed in the two-page spread state. In the disclosure, the book document means an original document constituted of a plurality of original documents that are bound as a book. In a book document reading mode, a plurality of pieces of image data, which are continuously obtained, are temporarily and readably stored in the main storage unit and the storage unit 40, which are described above, as an image data group, for analysis.

At Step S10, the user operates the operation display 50 to set an operation mode of the image forming apparatus 1 to the book document reading mode. The book document reading mode is an operation mode for reading a plurality of original documents that are bound as a book.

At Step S20, the user opens the book document and places (sets) for each page on the platen 170. The book document is opened to be placed on the platen 170 such that the original document of one page on one side in two-page-spread is readable.

At Step S30, the user presses a start button of the operation display 50. This causes the image reading unit 100 to read the image of the original document of the one page on the one side in the two-page-spread of the book document, so as to generate image data representing a page image. While the pages of the book document are turned as necessary, the user repeatedly obtains the image data and forms the image data group, which includes the plurality of pieces of image data as described above.

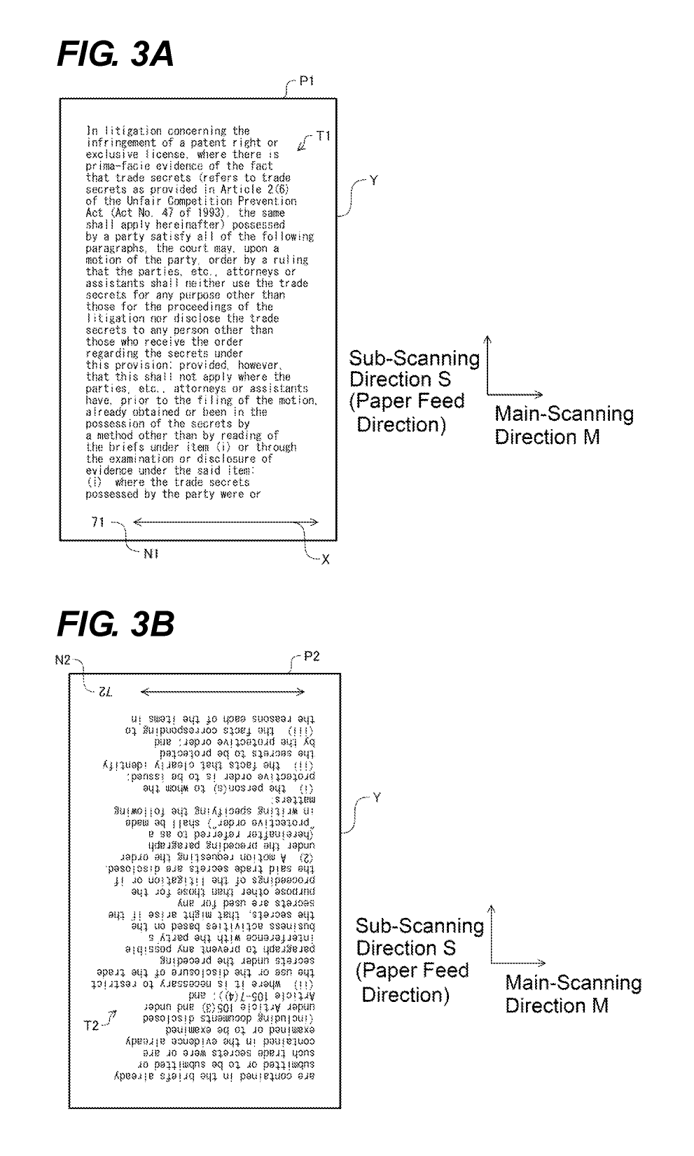

FIGS. 3A and 3B illustrate explanatory diagrams illustrating exemplary page images of the book document in the book document reading process procedure according to the one embodiment. FIG. 3A illustrates a first page image P1. FIG. 3B illustrates a second page image P2. The first page image P1 includes a body text region T1 and a page number region N1. The body text region T1 represents a body text of the original document. The page number region N1 represents a page number. The second page image P2 includes a body text region T2 and a page number region N2. The body text region T2 represents a body text of the original document. The page number region N2 represents a page number.

In this example, the first page image P1 and the second page image P2 are arranged in an opposite direction. The first page image P1 is obtained in response to the press of the start button, and the second page image P2 is obtained in response to the following press of the start button after Step S60 (described later).

At Step S40, the image analysis unit 30 of the image forming apparatus 1 analyzes the image data group to perform a document direction identification process. The document direction identification process is a process that identifies an arrangement direction for each page of the book document on the platen 170. Even when the direction of a part of the page images is changed (the page is disarranged) while the book document is read, the image analysis unit 30 uses the detected arrangement direction to cause the direction of the page image to align in a constant direction, so as to generate the image data.

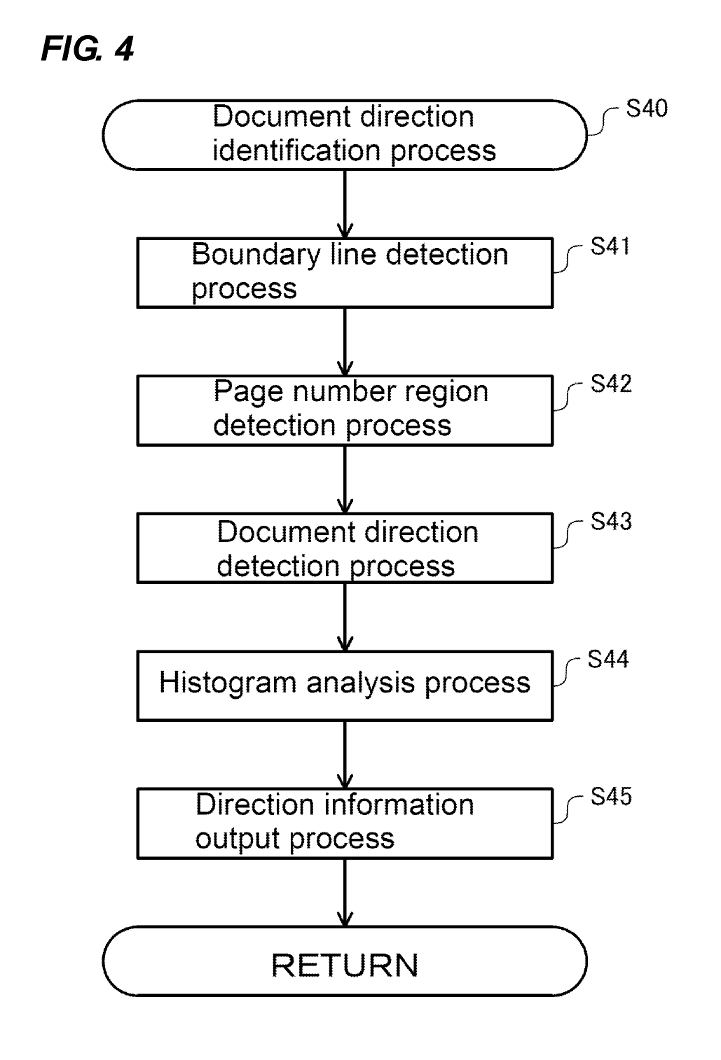

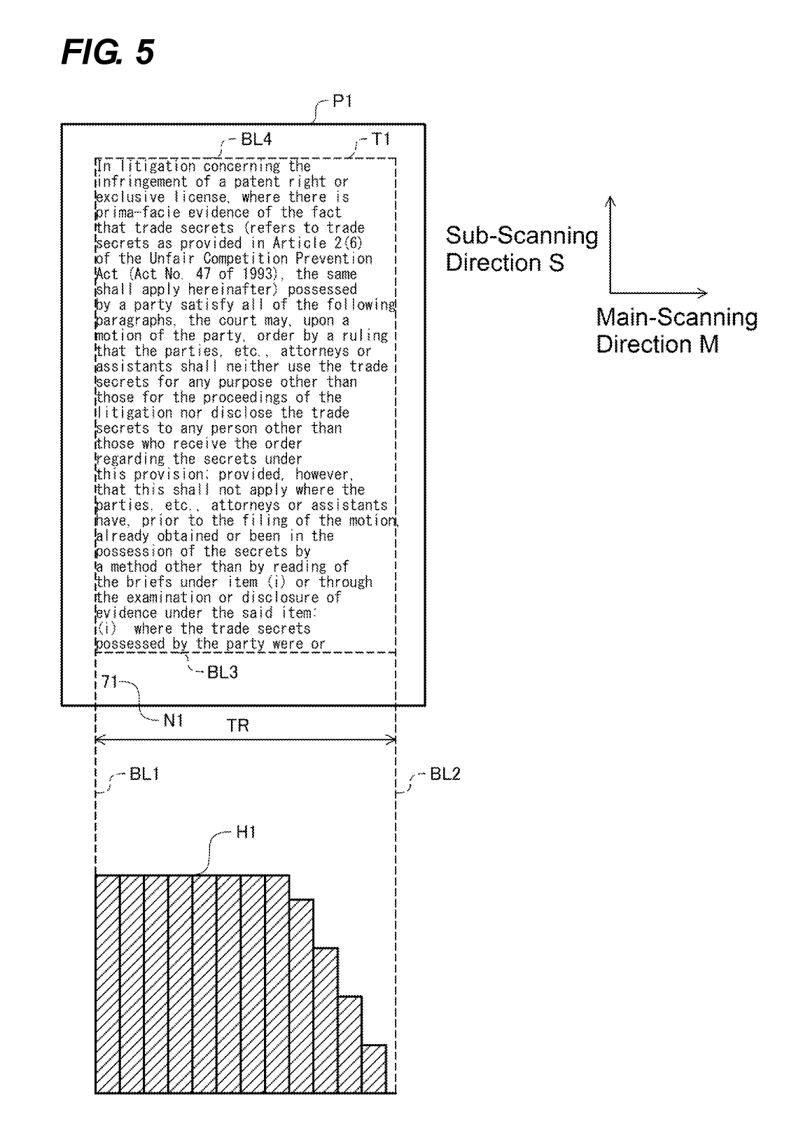

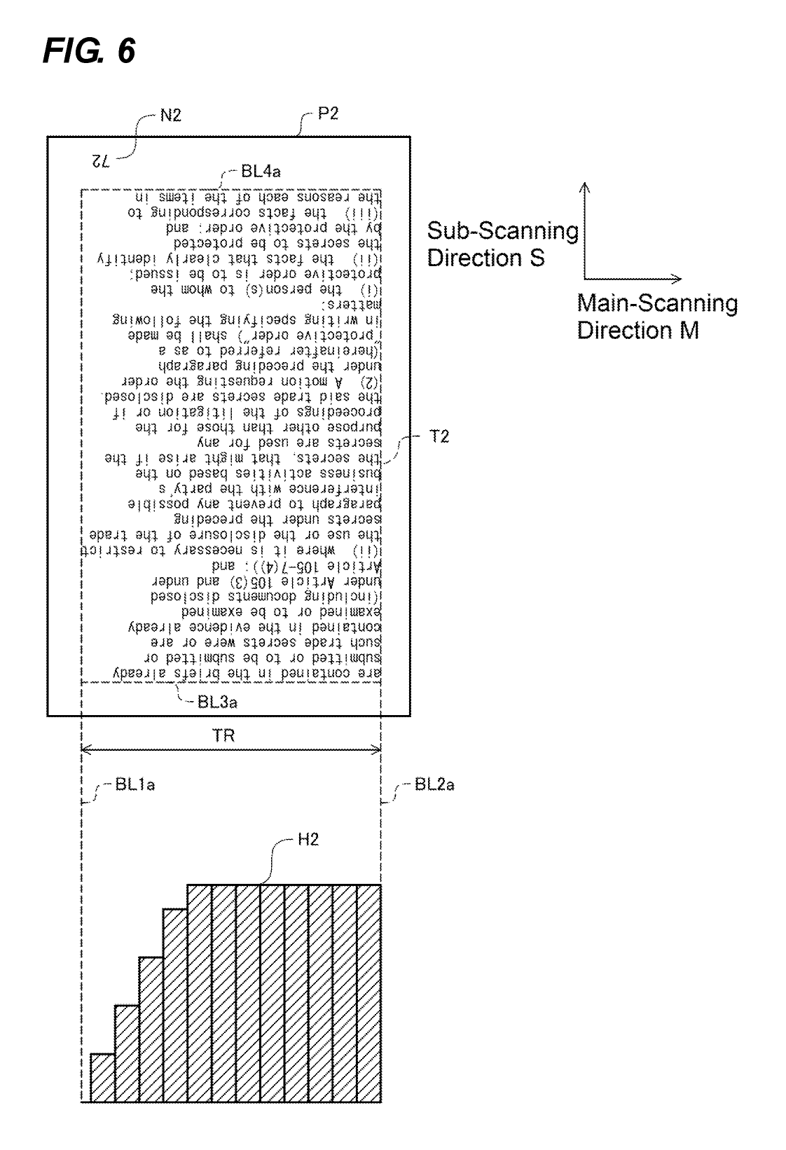

FIG. 4 illustrates contents of the document direction identification process (Step S40) according to the one embodiment. FIGS. 5 and 6 illustrate explanatory diagrams illustrating a histogram analysis process in the document direction identification process according to the one embodiment. At Step S41, the image analysis unit 30 performs a boundary line detection process. The boundary line detection process is a process that detects two pairs of boundary lines BL1 to BL4, which constitute boundaries of both ends of the body text region T1 in the main-scanning direction M and the sub-scanning direction S. In this example, the document direction identification process is performed based on the two-page images, which are continuously read, and identifies a direction of the second page image using a direction of the first page image as a reference.

Firstly, the image analysis unit 30 examines respective pixel values in the main-scanning direction M from the left side in the first page image P1 illustrated in FIG. 5, detects a position (the boundary line BL1 perpendicular to the main-scanning direction M) at which the body text region T1 starts, and detects a position (the boundary line BL2 perpendicular to the main-scanning direction M) at which the body text region T1 ends. Subsequently, the image analysis unit 30 examines respective pixel values in the sub-scanning direction S from the lower side in the first page image P1, detects a position (the boundary line BL3 perpendicular to the sub-scanning direction S) at which the body text region T1 starts, and detects a position (the boundary line BL4 perpendicular to the sub-scanning direction S) at which the body text region T1 ends.

Next, the image analysis unit 30 examines respective pixel values in the main-scanning direction M from the left side in the second page image P2 illustrated in FIG. 6, detects a position (a boundary line BL1a perpendicular to the main-scanning direction M) at which the body text region T2 starts, and detects a position (a boundary line BL2a perpendicular to the main-scanning direction M) at which the body text region T2 ends. Subsequently, the image analysis unit 30 examines respective pixel values in the sub-scanning direction S from the lower side in the second page image P2, detects a position (a boundary line BL3a perpendicular to the sub-scanning direction S) at which the body text region T2 starts, and detects a position (a boundary line BL4a perpendicular to the sub-scanning direction S) at which the body text region T2 ends.

At Step S42, the image analysis unit 30 performs a page number region detection process. The page number region detection process is performed using a typical arrangement of symmetrical page numbers above or below the body text regions T1 and T2 in two-page spread. In the first page image P1, the image analysis unit 30 searches a small image region at the proximity of end portions (that is, the right and left ends BL1 and BL2 of the body text region T1 in FIG. 5) in the main-scanning direction M outside (above and below) of end portions (that is, the upper and lower ends BL3 and BL4 of the body text region T1 in FIG. 5) of the body text region T1 in the sub-scanning direction S. In the second page image P2, the image analysis unit 30 searches a small image region at the proximity of end portions (that is, the right and left ends BL1a and BL2a of the body text region T2 in FIG. 6) in the main-scanning direction M outside (above and below) of end portions (that is, the upper and lower ends BL3a and BL4a of the body text region T2 in FIG. 6) of the body text region T2 in the sub-scanning direction S. The small image region is an image region having a size where a numeral display of one character to three characters, which is a common indication of a page number, is assumed.

At Step S43, the image analysis unit 30 performs a document direction detection process. The document direction detection process is performed by comparing the positions of the page number region N1 of the first page image P1 and the page number region N2 of the second page image P2. In this example, when the second page image P2 is rotated by 180 degrees, the image analysis unit 30 reproduces an arrangement where the page number regions N1 and N2 are symmetrical below the body text regions T1 and T2 in two-page spread. That is, in the first page image P1, the body text region T1 is relatively arranged on an upper side, and the page number region N1 is relatively arranged on a lower side, in the second page image P2, the body text region T2 is relatively arranged on the lower side, and the page number region N2 is relatively arranged on the upper side.

Thus, in the example of the first page image P1 and the second page image P2, the image analysis unit 30 determines that vertical directions of the first page image P1 and the second page image P2 at the time point of the reading are mutually opposite. This ensures detecting disarrangement in the directions of the first page image P1 and the second page image P2 even when a density change enough to determine a binding portion does not occur in a book document having the small number of pages.

At Step S44, the image analysis unit 30 performs the histogram analysis process. The histogram analysis process is a process that determines a document direction, where presence/absence of disarrangement is detected during the document direction detection process, based on the histogram analysis of the body text regions T1 and T2. The histogram analysis assumes a color original document and a monochrome original document and can be performed using, for example, a luminance.

For example, in the first page image P1, as illustrated in a histogram H1 in FIG. 5, the histogram analysis is a process that analyzes a trend (a trend of density reduction) of: a stepwise increase from the beginning of the texts along the direction (from left side to right side) of the texts of respective rows; and a gradual decrease toward the end of the texts in the body text region T1. This trend is caused by line break processes of the texts. This process utilizes a fact that most of the image represented in the body text region T1 is text. This process is similarly performed on the body text region T2. In the second page image P2, as illustrated in a histogram H2 in FIG. 6, this process analyzes a trend of: a stepwise increase from the beginning of the texts along the direction (from right side to left side) of the texts of respective rows; and a gradual decrease toward the end of the text in the body text region T2.

In the histogram analysis process, the image analysis unit 30 firstly performs in the main-scanning direction M, regardless of a document image at the time point of reading, so as to obtain luminance values at respective positions in the main-scanning direction M and then accumulates luminance values at respective positions in the sub-scanning direction S. This enables the image analysis unit 30 to obtain a histogram where the main-scanning direction M is assumed as a horizontal axis and a histogram where the sub-scanning direction S is assumed as a horizontal axis. Then the image analysis unit 30 confirms the document direction detected in the document direction detection based on whether the above-described features more remarkably appear in the histogram where which direction is assumed as the horizontal axis.

At Step S45, the image analysis unit 30 performs a direction information output process. The direction information output process is a process that outputs the document direction determined in the histogram analysis process.
(1) A first direction (direction at the time point of printing): an upper side direction of a page image corresponds to the sub-scanning direction S while the horizontal direction of the page image is parallel to the main-scanning direction M (an arrangement example in FIG. 3A)
(2) A second direction: the upper side direction of the page image corresponds to the direction of the main-scanning direction M while the horizontal direction of the page image is parallel to the sub-scanning direction S (a direction rotated clockwise by 90 degrees from the first direction)
(3) A third direction: the upper side direction of the page image is a direction opposite to the sub-scanning direction S while the horizontal direction of the page image is parallel to the main-scanning direction M (a direction rotated clockwise by 180 degrees from the first direction)
(4) A fourth direction: the upper side direction of the page image is a direction opposite to the main-scanning direction M while the horizontal direction of the page image is parallel to the sub-scanning direction S (a direction rotated clockwise by 270 degrees from the first direction)

In this example, when the first page image is arranged in the first direction, the body text region T1 and the page number region N1 have a first position relationship. When the second page image is arranged in the second to the fourth directions, the body text region T1 and the page number region N1 have a second position relationship. An image arranged in the first direction is referred to as a normal image, and an image arranged in the second to the fourth directions is also referred to as a disarranged image.

However, such definitions are relative, the following definitions may be defined: when the first page image (the normal image) is arranged in the second direction, the body text region T1 and the page number region N1 have the first position relationship; and when the second page image (the disarranged image) is arranged in the first, the third, and the fourth directions, the body text region T1 and the page number region N1 have the second position relationship.

At Step S50, the image analysis unit 30 performs a rotation process. Specifically, when the page image is arranged in the second direction, the third direction, and the fourth direction, the image analysis unit 30 rotates anticlockwise the page image in a direction of 90 degrees, 180 degrees, and 270 degrees, respectively, so as to arrange the page image in the first direction. Such process is repeatedly performed until the last page is detected (Step S60). A determination of the last page is performed when, for example, the fact of the last page is input on the operation display 50.

At Step S70, the image forming apparatus 1 performs an output process based on the image data where the document direction is aligned. The output process is performed when the image is formed on the print medium, or when electronic data where the book document is digitized is output.

Thus, the image forming apparatus 1 according to the embodiment detects the page number regions N1 and N2 without using a complicated image recognition technique, such as character recognition process (OCR) and labeling, thus enabling the image forming apparatus 1 to identify the direction of the page image based on a positional relationship between the body text regions T1 and T2 so as to align the directions of the plurality of document images. Furthermore, the image forming apparatus 1 determines also horizontal writing or vertical writing and can appropriately exchange an order of two pieces of image data, which are obtained for each page, as necessary.

This ensures providing a scanned image including the aligned document direction, which leads to high readability, to the user. Furthermore, the image forming apparatus 1 is advantageous in that the image forming apparatus 1 detects the direction of the page image even when a density change enough to determine a binding portion does not occur in a book document having the small number of pages.

The disclosure is not limited to the above-described embodiment and embodied as the following modifications.

### Modification 1

While in the above-described embodiment the image data is obtained for each page of the book document using the platen 170, the disclosure may be applied to the case where an image is read by the automatic document feeder (ADF) 160. Specifically, the disclosure may be applied to a book document reading process procedure where the ADF 160 reads the plurality of original documents, which are generated when the book document is cut, to digitize the book document.

When the book document is cut, disarrangement may be partially generated on the original documents among the plurality of original documents, which are produced when the book document is cut. Even when unevenness of the binding portion disappears because of the cutting, the disclosure detects disarrangement where the document direction faces a direction different from the other original documents and then automatically aligns them. Specifically, the image analysis unit 30 utilizes a fact that the page number region is detected on a lower left in an odd number page, and the page number region is detected on the lower left (or the opposite) in an even number page when the original documents in FIGS. 3A and 3B are cut, and when disarrangement is absent. The process is similarly performed on this respect when the ADF 160 has a function to read both sides and reads both sides, and the process is similarly performed after respective pieces of image data, which are formed when both the sides are read, are arranged in an order of the page.

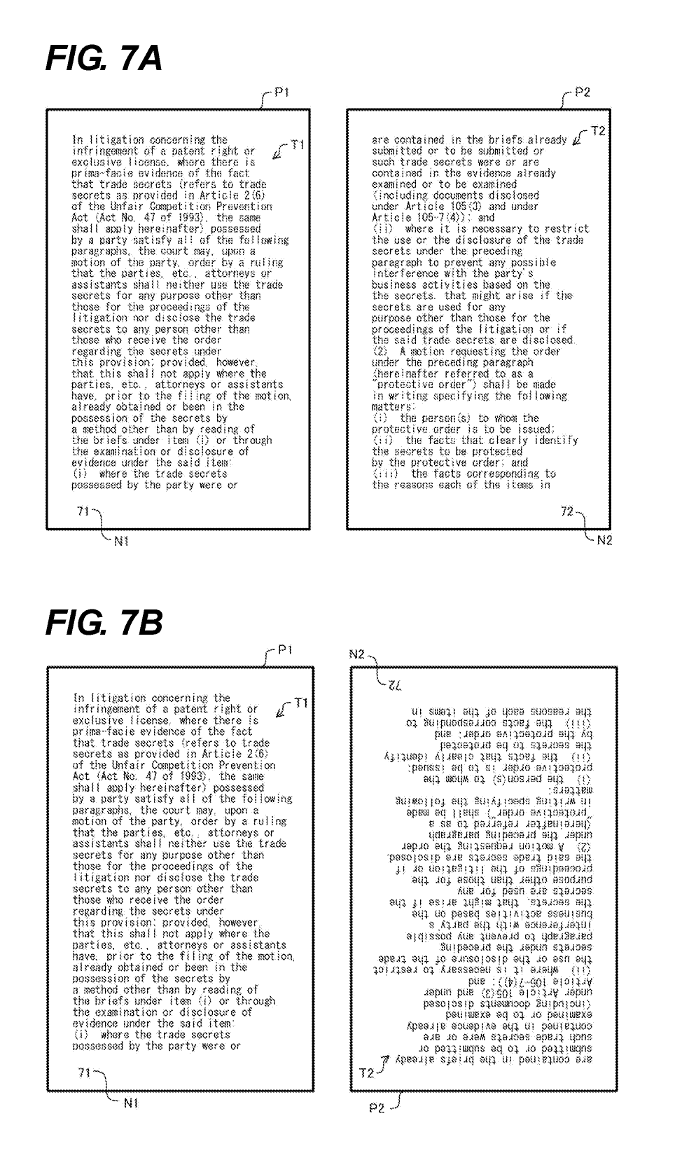

The control unit 10 stores a plurality of pieces of image data (see FIG. 7A) of an original document, which continuously are read by the ADF 160, in, for example, the storage unit 40, and the image analysis unit 30 detects whether positional consistency between a page number region in an image of each page and page number regions in images of the previous and following pages is ensured or not. At the time of reading with the ADF 160, it is limited to disarrangement (upside down) displaced by 180 degrees when the user places an original document on the ADF 160 (see FIG. 7B), and thus rotation by 180 degrees ensures the plurality of aligned document images.

### Modification 2

While in the above-described embodiment the disclosure is applied to the image forming apparatus including a small-sized platen, which is not available for reading of an image of a book document in the two-page spread state, the disclosure may be applied to, for example, a large-sized image forming apparatus, which is available for reading of an A3 image.

### Modification 3

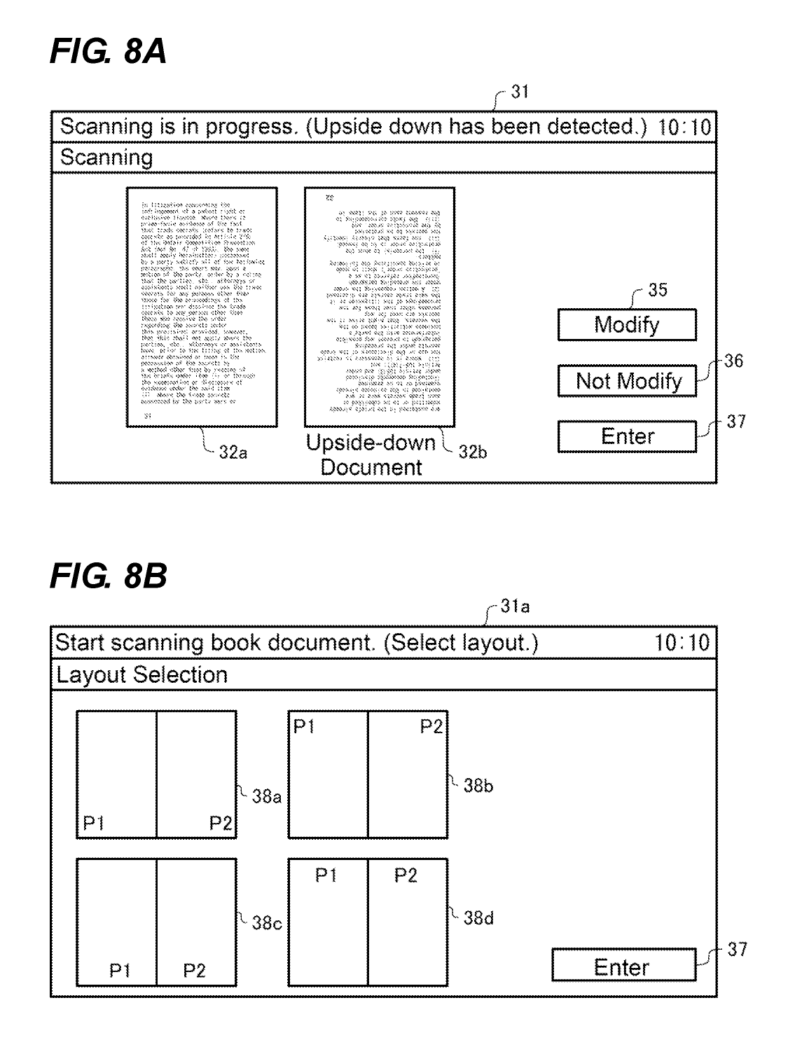

While in the above-described embodiment the alignment of the image data is automatically performed, the rotation process may be performed in response to an input operation from the user after the user confirms the document direction on a preview screen using, for example, a user interface screen 31, which is displayed on the operation display 50 illustrated in FIG. 8A. Specifically, the user interface screen 31 displays a document image of the previous page on the left next to an upside-down document 32b in response to a detection of the upside-down document 32b to facilitate comparison, and the preview screen displays an upside-down state. When the user performs a modification (upside down) after confirming a disarrangement state from this display, the user touches an icon 35 and then touches an enter icon 37. When the user does not perform modification (upside down), the user touches an icon 36 and then touches the enter icon 37. This ensures avoiding a rotation process unintended by the user.

Even in this case, when a direction (a direction alignable by a rotation of a first rotation angle) of the disarrangement, which is detected based on the positional relationship between the body text region and the page number region, matches a direction (a direction alignable by a rotation of a second rotation angle) having consistency with the result of the histogram analysis, it may be configured that the display of the user interface screen 31 is skipped and the rotation process is automatically performed.

### Modification 4

While in the above-described embodiment the pattern illustrated in an icon 38a or an icon 38b of a user interface screen 31a illustrated in FIG. 8B is assumed as a layout pattern of the book document, it is not necessarily limited to these layout patterns. For example, the disclosure may be applied to the book document having the layout pattern illustrated in an icon 38c or an icon 38d by selecting on the user interface screen 31a.

### Modification 5

While in the above-described embodiment the disclosure is applied to the image forming apparatus, the disclosure is also applicable to, for example, an image reading apparatus.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image reading apparatus comprising:
an image reading unit that ensures placing at least one original document among a plurality of original documents constituting a book document, the image reading unit reading images of the plurality of original documents in sequence so as to generate an image data group including a plurality of pieces of image data; and
an image analysis unit that analyzes the image data group to identify a body text region representing a body text of the original document, the image analysis unit identifying a page number region based on a position of the identified body text region, the page number region representing a page number, the image analysis unit determining a first position relationship as a positional relationship between the body text region and the page number region, the image analysis unit detecting a disarranged image, the disarranged image being an image of an original document having a second position relationship different from the determined first position relationship.

2. The image reading apparatus according to claim 1, wherein the image analysis unit processes image data representing the disarranged image by rotating the disarranged image by a first rotation angle such that the second position relationship becomes to have the first position relationship.

3. The image reading apparatus according to claim 1 further comprising an operation display, wherein:
the image analysis unit displays the disarranged image on the operation display and processes image data representing the disarranged image by rotating the disarranged image by a first rotation angle such that the second position relationship becomes to have the first position relationship in response to an input operation to the operation display.

4. The image reading apparatus according to claim 3, wherein the image analysis unit analyzes a histogram of a normal image and a histogram of the disarranged image, the normal image being an image of an original document having the first position relationship, the image analysis unit determining a second rotation angle of the disarranged image such that directions of density reduction of the normal image and the disarranged image match when a density reduction occurs in a direction different from the histogram of the normal image, the image analysis unit automatically rotating the disarranged image by the first rotation angle when the second rotation angle and the first rotation angle match.

5. The image reading apparatus according to claim 1, wherein the image reading unit ensures placing a plurality of original documents, automatically conveys the plurality of original documents one by one, and reads an image of at least one surface of the plurality of original documents so as to generate image data.

6. An image forming apparatus comprising:
the image reading apparatus according to claim 1; and
an image forming unit that forms an image on an image forming medium based on image data generated by the image reading apparatus.

7. An image reading method comprising:
placing at least one original document among a plurality of original documents constituting a book document, and reading images of the plurality of original documents in sequence so as to generate an image data group including a plurality of pieces of image data; and
analyzing the image data group to identify a body text region representing a body text of the original document, identifying a page number region based on a position of the identified body text region, the page number region representing a page number, determining a first position relationship as a positional relationship between the body text region and the page number region, and detecting a disarranged image, the disarranged image being an image of an original document having a second position relationship different from the determined first position relationship.

8. A non-transitory computer-readable recording medium storing an image reading program for controlling an image reading apparatus, the image reading program causing the image reading apparatus to function as:
an image reading unit that ensures placing at least one original document among a plurality of original documents constituting a book document, the image reading unit reading images of the plurality of original documents in sequence so as to generate an image data group including a plurality of pieces of image data; and
an image analysis unit that analyzes the image data group to identify a body text region representing a body text of the original document, the image analysis unit identifying a page number region based on a position of the identified body text region, the page number region representing a page number, the image analysis unit determining a first position relationship as a positional relationship between the body text region and the page number region, the image analysis unit detecting a disarranged image, the disarranged image being an image of an original document having a second position relationship different from the determined first position relationship.
